(19) United States
(12) Patent Application Publication
(10) Pub. No.: US 2008/0171834 A1
(43) Pub. Date: Jul. 17, 2008

(54) THERMOPLASTIC AND NUCLEATING AGENT COMPOSITIONS AND METHODS

(76) Inventors: Kien-Mun Tang, Singapore (SG); Christopher T. Kochanowicz, Spartanburg, SC (US)

Correspondence Address: Legal Department (M-495), P.O. Box 1926, Spartanburg, SC, 29304, US

(21) Appl. No.: 11/952,372

(22) Filed: Dec. 7, 2007

Related U.S. Application Data
(60) Provisional application No. 60/870,631, filed on Dec. 19, 2006.

(51) Int. Cl. C08F 8/40

(52) U.S. Cl. 525/340

(57) ABSTRACT

Certain thermoplastic additives that induce simultaneous good material properties and high nucleation efficacy are provided. Such additives include combinations of a phosphate salt and a dicarboxylate salt. This combination or blend may be provided in various ratios. A method for applying such a combination in a thermoplastic formulation is also disclosed. A thermoplastic formulation, which may or may not include polypropylene, is also disclosed in connection with the nucleating agent blend combination.

### CROSS-REFERENCE TO RELATED PATENT APPLICATIONS

This application claims, pursuant to 35 U.S.C. § 119(e), the benefit of the filing date of U.S. Patent Application No. 60/870,631 filed on Dec. 19, 2006.

### BACKGROUND

Nucleating and clarifying agents are chemical compositions that may be added to thermoplastic polymers to facilitate formation of the polymer as it changes from molten to solid form in the process of crystallization. Such additives may also assist in reducing haze of polymeric structures. One issue in the use of such agents is the amount or degree of clarity that the agent or additive imparts to a finished polymeric article. Reducing haze and thereby increasing clarity of such articles is a significant endeavor in the plastics industry. In general, the use of nucleating agents is a highly unpredictable technology area. Small or slight changes in molecular structure can significantly change the ability of a given nucleating composition to nucleate or clarify effectively a polymer composition. There is a large amount of unpredictability in the art and science of nucleating agents. There are many unknowns regarding the effect of a given substance on polymer morphology during recrystallization of thermoplastics.

Problems that may be encountered with conventional, commercially known nucleating agents include inconsistent nucleation due to dispersion problems, resulting in stiffness and impact variation in a polyolefin article. Substantial uniformity in polyolefin production is highly desirable because it results in relatively uniform finished polyolefin articles. If the resultant article does not contain a well-dispersed nucleating agent, the entire article itself may suffer from a lack of rigidity and low impact strength. Furthermore, temperature effects upon the finished article are important considerations as well.

A nucleating agent for polypropylene with a combination of positive material properties, like high Tc (peak crystallization temperature), low t_{1/2} (crystallization half-time), isotropic shrinkage, and high stiffness, is highly desirable. Phosphate ester salts, like NA-11 and NA-21 (manufactured by Asahi Denka Kogyo Kabushiki Kaisha of Japan) are known to incur relatively high stiffness in injection molded articles. However, warpage caused by anisotropic shrinkage is often an undesired side effect of such materials. This is a significant limitation of polymers clarified with such salts.

Heat resistance of polypropylene resin and plastic articles is also an important feature of polymers. Stiffness, especially at elevated temperatures is an important property of polymeric articles. There are certain applications, such as automotive parts and electrical appliances, which require higher heat resistance and improved thermal properties which cannot be realized with conventional nucleating agents. Heat deflection temperature is a property of polymeric articles that correlates to the stiffness of a polymeric article under an applied load, at elevated temperatures. There is a long-felt need in the polyolefin nucleator compound industry to provide excellent peak crystallization temperatures for the polyolefin, with good performance in relatively high heat environments.

### BRIEF SUMMARY

In a first embodiment, the invention provides a composition comprising a first nucleating agent comprising a carboxylic acid salt compound and a second nucleating agent comprising a bis-phenol phosphate compound. The composition can be used as a nucleating or clarifying composition for thermoplastics, such as polyolefins (e.g., polypropylene), polyesters, and polyamides. The composition may be employed as a powder blend, a liquid blend, or an additive pre-blend, in some applications. It may be mixed with other additives to form an additive “package”, and used as such. Also, this blend may be combined with a polymer, as a masterbatch, or in actual polymeric concentrations needed for polymeric articles. This blend may be provided, optionally, with acid scavengers and other additives as stabilizers. Acid scavengers that may be employed include, without limitation, zinc stearate, calcium stearate, or other stearate-containing compounds.

In certain embodiments of the composition, the first nucleating agent can comprise a carboxylic acid salt compound conforming to the formula below:

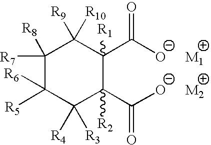

In the formula, M₁ and M₂ are the same, different, or may be combined into one cation, and are independently selected from the group consisting of metal or organic cations. R₁, R₂, R₃, R₄, R₅, R₆, R₇, R₈, R₉, and R₁₀ are individually selected from the group consisting of hydrogen, C₁-C₉ alkyl, hydroxyl, C₁-C₉ alkoxy, C₁-C₉ alkyleneoxy, amine, C₁-C₉ alkylamine, halogens, phenyl, alkylphenyl, and geminal or vicinal C₁-C₉ carbocyclic. In certain embodiments, M₁ and M₂ are individually or jointly selected from the group consisting of cations of calcium, strontium, barium, magnesium, aluminum, silver, sodium, lithium, rubidium, and potassium. In certain embodiments, R₁, R₂, R₃, R₄, R₅, R₆, R₇, R₈, R₉, and R₁₀ are each hydrogen. In certain embodiments of the composition, the carboxylic acid salt compound can be a compound conforming to the formula above in which M₁ and M₂ are together a calcium cation, R₁, R₂, R₃, R₄, R₅, R₆, R₇, R₈, R₉, and R₁₀ are each hydrogen, and the carboxylic acid moieties are provided in the cis configuration. Such a carboxylic acid salt compound is also known as calcium hexahydrophthalic acid (e.g., calcium HHPA or Ca HHPA) and is commercially sold as HYPERFORM® HPN-20E nucleating agent by Milliken & Company of Spartanburg, S.C.

In certain embodiments of the composition, the second nucleating agent can comprise a bis-phenol phosphate compound conforming to the formula below:

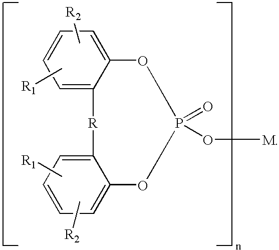

In the formula, R is selected from the group consisting of a carbon-to-carbon bond; thio sulfur (—S—); and alkylidene conforming to the formula

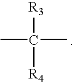

R₃ and R₄ are selected from the group consisting of hydrogen, C₁-C₁₈ alkyl, and cycloalkyl, including cycloalkylidene in which R₃ and R₄ together form part of a cycloalkylene ring having from three to about twelve carbon atoms. R₁ and R₂ each are selected from the group consisting of hydrogen, C₁-C₁₈ alkyl, and cycloalkyl having from about 3-12 carbon atoms. M is a metal atom or cation, such as a cation of an alkali metal atom or alkaline earth metal atom, and n is the valence of the metal atom or cation M. In certain embodiments of the composition, the bis-phenol phosphate compound can be a compound conforming to the formula above in which R is a C₁ alkylidene group (e.g., a methylene group), R₁ and R₂ are each tert-butyl groups attached to the 4 and 6 positions of the phenyl moieties, M is a sodium cation, and n is one. Such a bis-phenol phosphate compound is also known as 2,2′-methylene-bis-(4,6-di-tert-butylphenyl) phosphate and is commercially sold as NA-11 by Asahi Denka Kogyo K.K. of Japan.

### BRIEF DESCRIPTION OF THE DRAWINGS

FIG. 1 shows nucleating agent dosages for samples A, B, and C as described in Example 1 and Table 1.

FIG. 2 shows the haze measurements for samples A, B, and C.

FIG. 3 shows the peak crystallization temperature (Tc) for each of samples A, B, and C.

FIG. 4 shows heat deflection temperature results for each of samples A, B, and C.

FIG. 5 is a chart showing flexural modulus measurements for each of samples A, B, and C.

FIG. 6 shows Gardner impact test results for each of samples A, B, and C.

### DETAILED DESCRIPTION

The invention provides for improved heat resistance of conventional polymer resin, including for example homo-polypropylene resin. A blended nucleating agent mixture is employed, and may be applied in a polymer. The blend includes at least a first nucleating agent of a carboxylic acid salt compound and a second nucleating agent of a phosphate-containing salt compound. The carboxylic acid salt compound may be a dicarboxylic acid compound (two carboxyl groups). A thermoplastic polymer composition comprising both of these species of nucleating agent is disclosed. A thermoplastic polymer composition may be used, the composition comprising a first nucleating agent of a carboxylic acid salt compound and a second nucleating agent of a Bis-phenol phosphate compound.

One carboxylic acid metal salt compound that may be employed in the invention is represented by the following formula:

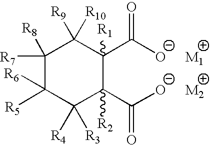

In the structure, M₁ and M₂ are the same or different and may be combined into one cation, and are selected from the group consisting of a metal cation of calcium, strontium, lithium or monobasic aluminum. R₁, R₂, R₃, R₄, R₅, R₆, R₇, R₈, R₉, and R₁₀ are either the same or different and are individually selected from the group consisting of hydrogen, C₁-C₉ alkyl, hydroxy, C₁-C₉ alkoxy, C₁-C₉ alkyleneoxy, amine, C₁-C₉ alkylamine, halogens, and phenyl.

Currently there are certain polymer applications (e.g. automotive, electrical appliances) which require higher heat resistance and improved thermal properties that cannot be realized (e.g., in polypropylene) by conventional nucleating agents. This invention may find applicability for such applications. As an example, in the practice of this invention, it has been shown that with appropriate blend mixtures, it is possible to further enhance the heat deflection temperature and maintain the flexural modulus.

The invention, in one embodiment, employs appropriate combinations of acid scavengers & additive packages together with blends of NA-11 & HPN-20E. A description of HPN-20E compound (which is commercially available and sold by Milliken & Company of South Carolina, USA) is shown herein. (“HPN-20E” is a trademark of Milliken & Company, which reserves all rights for its use in commerce). The stiffness and heat resistance of polymeric articles made using a combination of NA-11 and HPN-20E nucleating agents also may be employed in the practice of the invention. The beneficial results of such a blend of nucleating agents are unexpected.

HPN-20E is a compound that may be applied in one application of the invention. The additive product HPN-20E is also referred to as “Ca HHPA” (calcium hexahydrophthalic acid), the structure of which is shown below:

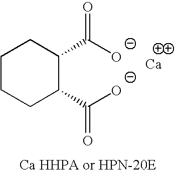

The invention involves, in one particular embodiment, a composition of the nucleating agent blend of HPN-20E and NA-11. This composition may be employed as a powder blend, a liquid blend, or an additive pre-blend, in some applications. It may be mixed with other additives to form an additive “package”, and used as such. Also, this blend may be combined with a polymer, as a masterbatch, or in actual polymeric concentrations needed for polymeric articles. This blend may be provided, optionally, with acid scavengers and other additives as stabilizers. Acid scavengers that may be employed include, without limitation, zinc stearate, calcium stearate, or other stearate-containing compounds.

The acid scavengers for NA-11 and HPN-20E that are used may employ a blend, including also additives of DHT-4A (a hydrotalcite compound; see description herein) and zinc stearate (“Zn St”). Other additives in the additive package may include primary and secondary antioxidants (such as Irganox 1010 or Irgafos 168). In the practice of the invention, it has been found that blends of HPN-20E with NA-11 show an improved performance compared to that shown by using only NA-11 itself, as illustrated by the examples herein.

Solid bicyclo[2.2.1]heptane dicarboxylate salt-containing thermoplastic nucleating additive formulations are used and sold in the industry, and also could be employed in the practice of the invention. Milliken and Company of Spartanburg, S.C. distributes commercial nucleating agents of such metal salts, under the trademark HYPERFORM®. One such product is known commercially as HPN-68®, which is sold by Milliken and Company. U.S. Pat. Nos. 6,465,551; 6,559,211; 6,521,685; and 6,583,206 relate to such compounds and their use. The dicarboxylate salt is usually provided as a granular formulation, and is known as a very good nucleating agent, particularly for applications that require high crystallization temperatures (Tc). This compound also can be used in a blend of the present invention, as combined with a phosphate-containing nucleating agent compound.

Also of interest is the compatibility of such nucleating agent or additive compounds with typical polyolefins (e.g., polypropylene, polyethylene, ethylene, and copolymer polypropylene). Unfortunately, many nucleators exhibit much deleterious nucleating efficacy with such compounds within polyolefin articles. The invention may employ acid scavengers. Also, other nonionic acid neutralizers, such as dihydrotalcite (DHT4-A), sometimes are necessary for use in conjunction with such nucleating agent blends in the practice of the invention. Other hydrotalcite compounds could be used as well, in various embodiments of the invention.

Another nucleating agent compound useful in the nucleating agent blend of the invention includes sodium 2,2′-methylene-bis-(4,6-di-tert-butylphenyl) phosphate (from Asahi Denka Kogyo K.K., known commercially as NA-11). The structure of NA-11 is shown below, in which “t-Bu” represents a tert-butyl group. However, it is recognized that many phosphate-containing species could be employed in the blend of the invention, and that the invention is not limited to only that phosphate containing species shown.

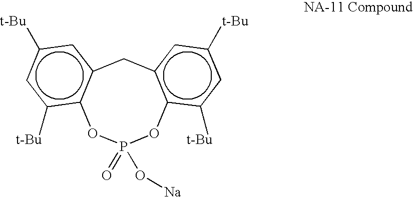

One aspect of the invention is to provide a thermoplastic additive composition having a blend of both a carboxylate or dicarboxylate metal salt nucleating agent and a phosphate-containing salt compound that simultaneously induces high levels of nucleation efficiency as well as low degrees of haze (and thus excellent clarity) within thermoplastic articles. Further, a polymer or thermoplastic with a higher heat deflection temperature (HDT), and with comparable stiffness may be achieved. Additionally, the invention provides a nucleator/clarifier blended additive composition that may be used in various polyolefin media for use in many end uses.

Accordingly, this invention is directed in one aspect to a nucleating or clarifying agent composition that is a combination of a phosphate salt (or organic phosphate salt) and a dicarboxylate metal salt. The phosphate salt may be a Bis-phenol compound. This combination or blend may be provided in various ratios. The invention also includes a method for applying such a combination in a thermoplastic formulation, and also the formulation containing the combination.

The nucleating agent blend of the invention exhibits chemical synergy, and presents results that are unexpected when used in polymers. In general, it is widely known that a combination of two different types of nucleating agents in one plastic or thermoplastic leads to the result that one of the nucleators overrides essentially all the effects of the other nucleating agent. This is a common and widely understood principle in the art of nucleation. However, in the practice of the invention, surprisingly, it has been discovered that the addition of two specific types of nucleating agents (as set forth herein) will change heat deflection temperature (“HDT”) of polymer articles favorably without negatively impacting mechanical properties such as Gardner impact, and without significant negative impact on crystallization temperature of the resulting polymer. This is the case, even though the crystallization temperatures and crystallization half times of the resulting nucleated polymers are slightly affected.

As used herein, the term “thermoplastic” refers generally to a polymeric material that will melt upon exposure to sufficient heat but will retain its solidified state upon cooling. “Thermoplastic” refers to plastics having crystalline or semi-crystalline morphology upon cooling after melt-formation, usually by the use of a mold or like article. Particular types of polymers contemplated within such a definition include, without limitation, polyolefins (such as polyethylene, polypropylene, polybutylene, and any combination thereof), polyamides (such as nylon), polyurethanes, polyester (such as polyethylene terephthalate), and the like (as well as any combinations thereof).

Thermoplastics have been utilized in a variety of end-use applications, including storage containers, medical devices, food packages, plastic tubes and pipes, shelving units, and the like. Such base compositions, however, must exhibit certain physical characteristics in order to permit widespread use. Specifically within polyolefins, for example, uniformity in arrangement of crystals upon crystallization is necessary to provide an effective, durable, and versatile polyolefin article. In order to achieve such desirable physical properties, it has been known that certain compounds and compositions provide nucleation sites for polyolefin crystal growth during molding or fabrication. Generally, compositions containing such nucleating compounds crystallize at a much faster rate than un-nucleated polyolefin. Such crystallization at higher temperatures results in reduced fabrication cycle times and a variety of improvements in physical properties, such as stiffness (as measured by HDT).

A method of the invention includes the steps of (a) providing a molten thermoplastic formulation; (b) introducing to such formulation and mixing therein a composition comprising at least one phosphate-containing salt and at least one dicarboxylate-containing salt, and (c) allowing the resultant composition to cool into a thermoplastic article.

### Salts of Dicarboxylates

Some particular, non-limiting examples of carboxylic acid salt compounds useful in the embodiments of the invention include the metal or organic salts of dicarboxylates, and most preferably those compounds conforming to the structure shown below:

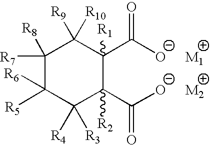

In the structure, M₁ and M₂ are the same or different, or M₁ and M₂ are combined to from a single moiety, and are independently selected from the group consisting of metal or organic cations. R₁, R₂, R₃, R₄, R₅, R₆, R₇, R₈, R₉, and R₁₀ are individually selected from the group consisting of hydrogen, C₁-C₉ alkyl, hydroxyl, C₁-C₉ alkoxy, C₁-C₉ alkyleneoxy, amine, C₁-C₉ alkylamine, halogen, phenyl, alkylphenyl, and geminal or vicinal C₁-C₉ carbocyclic. In certain embodiments, M₁ and M₂ are the same or different and may be combined into one cation, and are selected from the group consisting of a metal cation of calcium, strontium, lithium or monobasic aluminum; and R₁, R₂, R₃, R₄, R₅, R₆, R₇, R₈, R₉, and R₁₀ are either the same or different and are individually selected from the group consisting of hydrogen, C₁-C₉ alkyl, hydroxy, C₁-C₉ alkoxy, C₁-C₉ alkyleneoxy, amine, C₁-C₉ alkylamine, halogens, and phenyl wherein.

The metal cations (M₁ and M₂) can be selected from the group consisting of calcium, strontium, barium, magnesium, aluminum, silver, sodium, lithium, rubidium, potassium, and the like. Within that scope, group I and group II metal ions are generally quite effective. Among the group II and II cations, sodium, potassium, calcium and strontium are useful, wherein sodium and calcium are very useful. Furthermore, the M₁ and M₂ groups may also be combined to form a single metal cation (such as calcium, strontium, barium, magnesium, aluminum, and the like).

### Cyclic Phosphates

In some instances, the Bis-phenol phosphates that may be used in the embodiments of the invention include those conforming to the structure below:

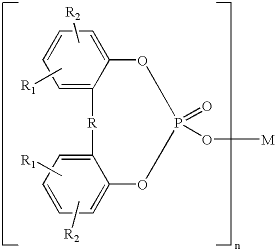

In this structure, R is selected from the group consisting of a carbon-to-carbon bond; thio sulfur (—S—); and alkylidene conforming to the formula

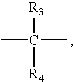

in which R₃ and R₄ are selected from the group consisting of hydrogen, alkyl having from one to about eighteen carbon atoms, and cycloalkyl, including cycloalkylidene in which R₃ and R₄ are taken together as part of a cycloalkylene ring, having from three to about twelve carbon atoms. R₁ and R₂ each are selected from the group consisting of hydrogen, alkyl having from about one to about eighteen carbon atoms; and cycloalkyl having from about 3-12 carbon atoms. Typically, M is a metal atom selected from alkali metal atoms or alkaline earth metal atoms; n is the valence of the metal atom M and ranges from 1 to 2, R is alkylidene, and R₁ and R₂ may be alkyl. In some embodiments, R is thio sulfur (—S—) and R₁ and R₂ are each alkyl. For some applications, R is a carbon-to-carbon bond, and R₁ and R₂ are each alkyl. R may be cycloalkylidene, and R₁ and R₂ may be each alkyl.

In yet other applications, R₁ and R₂ may be t-alkyl, and R may comprise alkylidene. R may be provided as a carbon-to-carbon bond. Bis-phenol phosphates may be employed in which R is thio sulfur (—S—). R₃ and R₄ may each be hydrogen as well. Furthermore, R₃ may be hydrogen, and R₄ may be alkyl. R₃ may be hydrogen, and R₄ may be cycloalkyl. Alternatively, R₃ and R₄ may be taken together as cycloalkylidene. Bis-phenol phosphates may be provided in which M is an alkali metal. M may be an alkaline earth metal. M may be a polyvalent metal. R₁ and R₂ may be each tertiary alkyl. R₁ may be hydrogen, and R₂ may be tertiary alkyl. R₁ may be hydrogen, and R₂ may be cycloalkyl.

Exemplary R alkylidene include at least the following, but are not limited to the following: methylidene, ethylidene, propylidene, isopropylidene, butylidene, isobutylidene, sec-butylidene, tert-butylidene, amylidene, hexylidene, heptylidene, octylidene, isooctylidene, 2-ethyl hexylidene, nonylidene and decylidene; cyclohexylidene, cycloheptylidene, methyl cyclohexylidene, ethyl cyclohexylidene, and cyclooctylidene.

Exemplary R₁ and R₂, R₃ and R₄ alkyl include methyl, ethyl, propyl, isopropyl, n-butyl, isobutyl, sec-butyl, t-butyl, amyl, t-amyl, hexyl, heptyl, octyl, 2-ethylhexyl, t-octyl, nonyl, decyl, undecyl, dodecyl, tridecyl, tetradecyl, pentadecyl, hexadecyl, heptadecyl and octadecyl.

Exemplary R₁ and R₂, R₃ and R₄ cycloalkyl include cyclopropyl, cyclobutyl, cyclopentyl, methylcyclopentyl, cyclohexyl, methylcyclohexyl, cycloheptyl, cyclooctyl and cyclododecyl.

Exemplary M monovalent metals include Li, Na, K. Exemplary bivalent metals include Be, Ca, Sr, Ba, Zn, and Cd. Exemplary trivalent and tetravalent metals include Al, Ge, Sn, Pb, Ti, Zr, Sb, Cr, Bi, Mo, Mn, Fe, Co and Ni. Among these metals, the alkali metals such as Li, Na and K and the alkaline earth metals such as Mg, Ca, Sr and Ba are known to be useful.

Compounds useful for nucleation in the combination of the invention include, but are not limited to, sodium 2,2′-methylene-bis-(4,6-di-tert-butylphenyl) phosphate (from Asahi Denka Kogyo K.K., known commercially as NA-11), talc, and the like. The invention may employ essentially any cyclic group having a phosphate attached. Bicyclic, tricyclic, and the like may be employed, with a phosphate salt, as one example.

In one embodiment, the combination of the invention comprises both a multi-cyclic phosphate salt and organic salts of saturated bicyclic dicarboxylates.

As indicated, the structure of NA-11 is one example of a phosphate-containing nucleator that may be employed. Its structure is shown below:

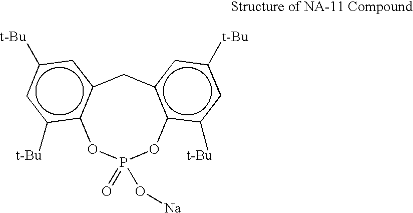

Although polyolefins are preferred, the nucleating agents of the present invention are not restricted to use in polyolefins, and may also give beneficial nucleation properties to polyesters such as polyethylene terephthalate (PET), polybutylene terephthalate (PBT), and polyethylene naphthalate (PEN), as well as polyamides such as Nylon 6, Nylon 6,6, and others. Generally, many different types of thermoplastic compositions having some crystalline content may be improved with the nucleating agents of the present invention.

### The HDT Test

“HDT” is an acronym for Heat Deflection Temperature. This is a commonly used industry test for resistance to temperature. To conduct the test, a small test bar is placed in a temperature controlled oil bath in which the oil is slowly heated while the bar is held under a constant load. As the oil bath slowly heats up, the test bar will finally flex a certain distance under the load. The oil bath temperature is recorded (“HDT”) at the point where the test bar flexes a certain distance. This is important in applications where a part may experience heat, such as a microwave application where a high HDT is desirable so that the part will be stiff enough when it is removed from the oven without spilling or collapsing, or an automotive application in which a part under the hood would be exposed to high heat conditions.

The following examples further illustrate the subject matter described above but, of course, should not be construed as in any way limiting the scope thereof.

### EXAMPLE 1

Samples were made to evaluate nucleating agent blend performance in a polypropylene homopolymer (i.e., HPP 6301). The following formulations were compounded on a single screw Killion extruder at about 220 degrees Celsius in HPP 6301 with 500 ppm Irganox 1010 and 1000 ppm Irgafos 168. Samples A, B, and C were prepared, as follows:
A. 1000 ppm NA-11 with 600 ppm DHT4A (Control)
B. 350 ppm HPN-20E with 650 ppm NA-11; and also 210 ppm Zinc Stearate, 390 ppm DHT4A (hydrotalcite).
C. 350 ppm HPN-20E, 650 ppm NA-11, 210 ppm Calcium Stearate and 390 ppm DHT4A (hydrotalcite).

The materials used in this example were as follows:
Resin: Basell Pro-fax homopolymer 6301, melt flow index 12 g/10 mins, specific gravity 0.90;
Antioxidants: Ciba's primary antioxidant Irganox 010 (high molecular weight phenolic antioxidant) and secondary antioxidant Irgafos 168 (phosphite); Acid scavengers: SunAce Kakoh Zinc Stearate (ZnSt), Calcium Stearate (CaSt), Ciba's DHT4A (hydrotalcite);
Nucleators: Asahi Denka's NA-11 (phosphate ester salt) and Milliken HPN-20E

After the above formulations were compounded, they were individually molded on an Arburg 25 ton molding machine into ASTM test samples for Flexural Modulus and Heat Deflection Temperatures testing. The samples were conditioned for a period of 7 days prior to ASTM testing so as to stabilize the samples.

Typical injection molding conditions were as follows:

| | |
|---|---|
| Feed/Zone 1/Zone 2/Zone 3/Nozzle (deg C.) | 220/220/225/230/230 |
| Injection Pressure (bar) | 250 |
| Holding Pressure (bar) | 230 |
| Injection Speed (ccm/s) | 5/10 |
| Holding Time (s) | 6 |
| Cooling Time (s) | 10 |
| Switch Over Volume (ccm) | 1.5 |
| Volume (ccm) | 10, 12.5 |
| Circum. Speed (m/min) | 10 |
| Mold temp. (Deg C.) | 25 |

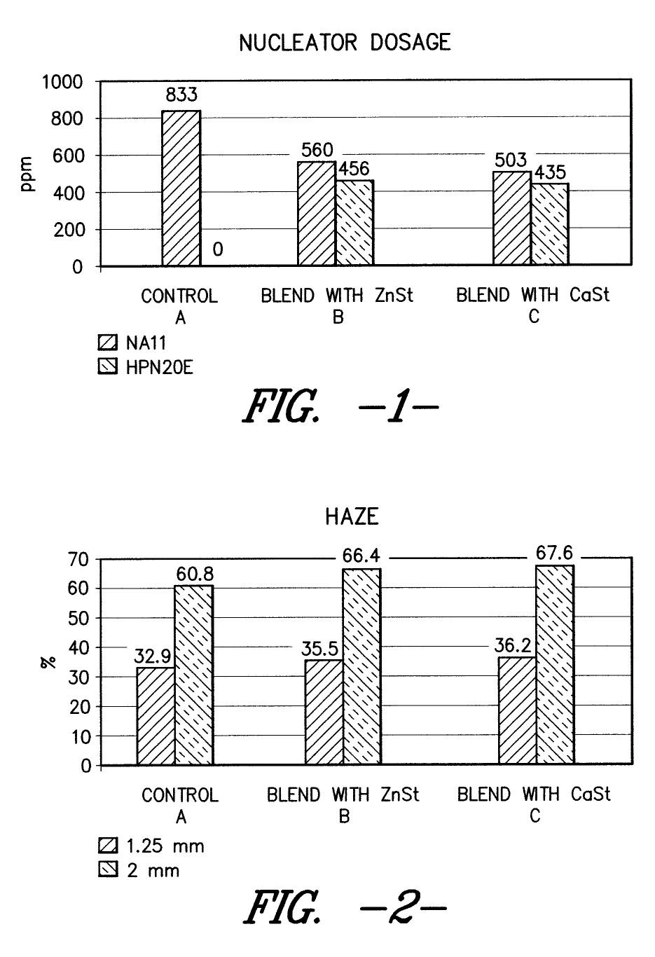

Results of the Flexural Modulus and Heat Deflection Temperature testing are shown in Table 1 and FIGS. 1-6 as further described.

TABLE 1
Heat Deflection Temperature (HDT)
and Flexural Modulus Results

| | Heat Deflection | Flexural Modulus |
|---|---|---|
| Formulation | Temperature (deg C.) | (M Pa) |
| Sample A | 118.6 | 1878 |
| 1000 ppm NA-11 | | |
| 600 ppm DHT-4A | | |
| Sample B | 122.2 | 1911 |
| 350 ppm HPN-20E | | |
| 650 ppm NA-11 | | |
| 210 ppm Zinc Stearate | | |
| 390 ppm DHT-4A | | |
| Sample C | 122.0 | 1825 |
| 350 ppm HPN-20E | | |
| 650 ppm NA-11 | | |
| 210 ppm Calcium Stearate | | |
| 390 ppm DHT-4A | | |

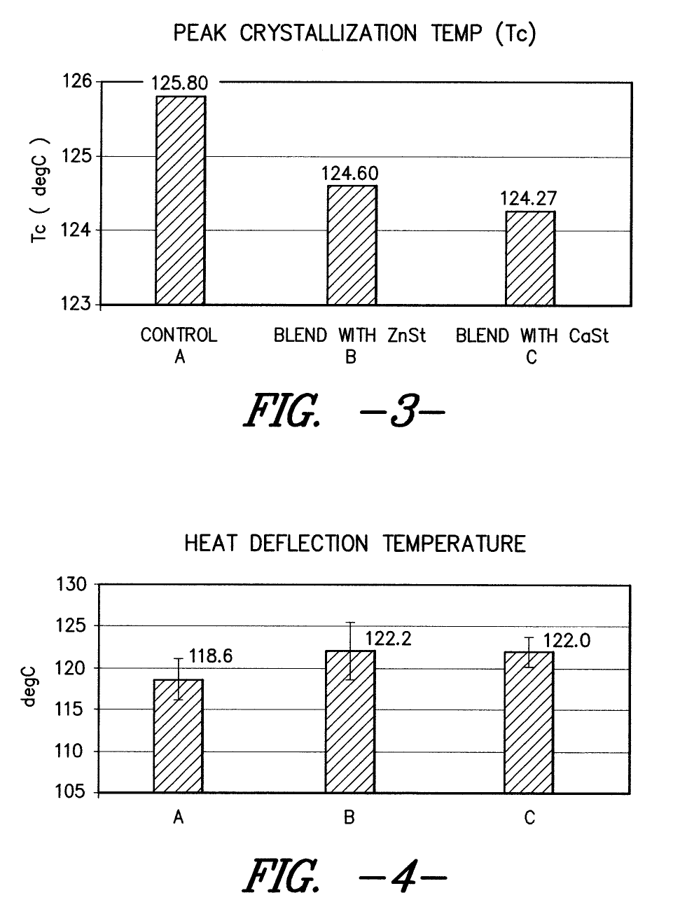

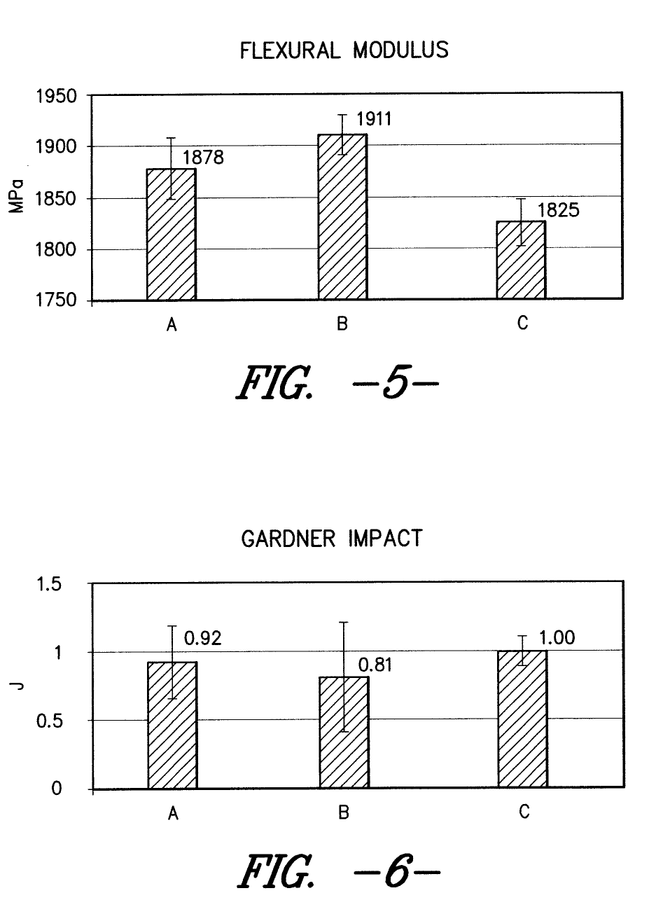

FIG. 1 shows nucleating agent dosage results in graphic form for samples A, B, and C. FIG. 2 shows the results of the haze measurements for samples A, B, and C. FIG. 3 shows peak crystallization temperature (Tc) of those same samples, while FIG. 4 shows heat deflection temperature. FIG. 5 is a chart showing flexural modulus of those samples. FIG. 6 shows Gardner impact test results of the same samples.

The results indicated that the heat deflection temperature (HDT) of HPN-20E & NA-11 blends with both Zinc Stearate & DHT-4A hydrotalcite gave a higher HDT (i.e. about 3.5 deg C. higher) than the 100% NA-11 formulation without HPN-20E. This improved property was achieved with no significant change in the stiffness. Furthermore, the Tc was lower by about 1.5 degrees Celsius, versus the 100% NA-11 formulation. The Gardner impact value was not significantly different between all the formulations. Furthermore, zinc stearate (ZnSt) seemed to be just slightly improved compared to blends that were otherwise the same but employed calcium stearate (CaSt).

### EXAMPLE 2

Samples were made to evaluate nucleating agent blend performance in a 20 MFR impact copolymer base flake. They were compounded on a single screw Deltaplast extruder at a maximum barrel temperature of 230 degrees Celsius with 500 ppm Irganox 1010 and 1000 ppm Irgafos 168. The samples were formulated as shown in Table 2.

TABLE 2
Sample Compositions for Evaluation

| | NA-11 | HPN-20E | | Calcium |
|---|---|---|---|---|
| Sample | (ppm) | (ppm) | DHT-4A | Stearate |
| D | 0 | 800 | 0 | 600 |
| E | 0 | 1100 | 0 | 600 |
| F | 800 | 0 | 400 | 0 |
| G | 1100 | 0 | 400 | 0 |
| H | 825 | 275 | 390 | 210 |
| I | 715 | 385 | 390 | 210 |

After the above formulations were compounded, they were individually prepared on an Arburg 40 ton injection molder into ASTM test samples for Flexural Modulus and Heat Deflection Temperatures testing. The samples were conditioned for a period of 7 days prior to ASTM testing so as to stabilize the samples.

Injection molding conditions were as follows:

| | |
|---|---|
| Barrel temp (deg C.) | 230 |
| Holding Pressure (bar) | 120-170 |
| Injection Speed (ccm/s) | 15.0 |
| Switch Over Volume (ccm) | 1.5-2.9 |
| Volume (ccm) | 12.1 |
| Mold temp. (Deg C.) | 24.7 |

Results of HDT and flexural testing are shown in Table 3.

TABLE 3
Heat Deflection Temperature (HDT)
and Flexural Modulus Results

| | | 1% Secant |
|---|---|---|
| | HDT at 455 | Modulus |
| Sample | kPa (C.) | (MPa) |
| D | 101.2 | 1277 |
| E | 101.2 | 1282 |
| F | 104.4 | 1287 |
| G | 103.5 | 1291 |
| H | 105.5 | 1318 |
| I | 105.3 | 1299 |

The results indicated that the heat deflection temperature (HDT) of HPN-20E & NA-11 gave a higher HDT than either nucleator when present alone. This improved property was achieved with no significant change in the stiffness.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the subject matter of this application (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter of the application and does not pose a limitation on the scope of the subject matter unless otherwise claimed. No language in the specification should be construed as indicating any non-claimed element as essential to the practice of the subject matter described herein.

Preferred embodiments of the subject matter of this application are described herein, including the best mode known to the inventors for carrying out the claimed subject matter. Variations of those preferred embodiments may become apparent to those of ordinary skill in the art upon reading the foregoing description. The inventors expect skilled artisans to employ such variations as appropriate, and the inventors intend for the subject matter described herein to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

What is claimed is:

1. A composition comprising:
(a) a first nucleating agent comprising a carboxylic acid salt compound, said carboxylic acid salt compound conforming to the formula below: 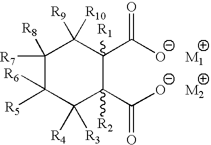
wherein M₁ and M₂ are the same, different, or may be combined into one cation, and are independently selected from the group consisting of a metal or organic cations;
wherein R₁, R₂, R₃, R₄, R₅, R₆, R₇, R₈, R₉, and R₁₀ are individually selected from the group consisting of hydrogen, C₁-C₈ alkyl, hydroxyl, C₁-C₈ alkoxy, C₁-C₈ alkyleneoxy, amine, C₁-C₈ alkylamine, halogens, phenyl, alkylphenyl, and geminal or vicinal C₁-C₈ carbocyclic; and
(b) a second nucleating agent comprising a Bis-phenol phosphate compound.

2. The composition of claim 1, wherein said Bis-phenol phosphate compound conforms to the formula below: 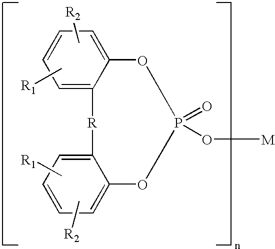
wherein R is selected from the group consisting of a carbon-to-carbon bond; thio sulfur—S—; and alkylidene conforming to the formula 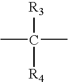
in which R₃ and R₄ are selected from the group consisting of hydrogen, alkyl having from one to about eighteen carbon atoms, and cycloalkyl, including cycloalkylidene in which R₃ and R₄ are taken together as part of a cycloalkylene ring, having from three to about twelve carbon atoms;
wherein R₁ and R₂ each are selected from the group consisting of hydrogen, alkyl having from about one to about eighteen carbon atoms, and cycloalkyl having from about 3-12 carbon atoms;
wherein M is a metal atom selected from the group consisting of alkali metal atoms and alkaline earth metal atoms; and
wherein n is the valence of the metal atom M, and ranges from 1 to 2.

3. The composition of claim 1 wherein said carboxylic acid salt compound comprises at least one cation selected from the group of: sodium, potassium, calcium, lithium, rubidium, barium, magnesium, strontium, silver, zinc, aluminum.

4. The composition of claim 3 wherein the cation comprises calcium.

5. A thermoplastic composition comprising a thermoplastic polymer and the composition of claim 1.

6. The thermoplastic composition of claim 5 wherein the thermoplastic polymer is polypropylene.

7. The composition of claim 2, wherein, in the structure of the Bis-phenol phosphate, R is an alkylidene conforming to the formula 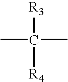
and R₁ and R₂ are both alkyl.

8. A method of making a thermoplastic article having improved physical properties, the method comprising the steps of:
(a) providing a thermoplastic formulation;
(b) combining with such formulation a nucleating agent composition comprising a Bis-phenol phosphate salt compound;
(c) combining with said formulation at least one dicarboxylate-containing salt compound, said dicarboxylate-containing salt compound conforming to the formula below: 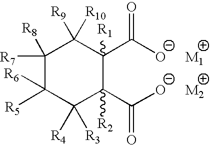
wherein M₁ and M₂ are the same, different, or may be combined into one cation, and are independently selected from the group consisting of a metal or organic cations;
wherein R₁, R₂, R₃, R₄, R₅, R₆, R₇, R₈, R₉, and R₁₀ are individually selected from the group consisting of hydrogen, C₁-C₉ alkyl, hydroxyl, C₁-C₉ alkoxy, C₁-C₉ alkyleneoxy, amine, C₁-C₉ alkylamine, halogens, phenyl, alkylphenyl, and geminal or vicinal C₁-C₉ carbocyclic; and
(d) forming with said formulation a thermoplastic article.
